(19) United States
(12) Patent Application Publication
(10) Pub. No.: US 2007/0119445 A1
(43) Pub. Date: May 31, 2007

(54) Multifunctional cooking apparatus

(76) Inventor: Yueh-Chiang Wen, Taichung Hsien (TW)

Correspondence Address: PRO-TECHTOR INTERNATIONAL SERVICES, 20775 NORADA CT., SARATOGA, CA, 95070, US

(21) Appl. No.: 11/290,239

(22) Filed: Nov. 29, 2005

(51) Int. Cl. A47J 37/07

(52) U.S. Cl. 126/25 AA

(57) ABSTRACT

A cooking apparatus includes a grill; a stove assembly adapted to mount on the grill and including a top opening, a heating block, a frame on the opening, a pan on the frame, a rotation adjustment knob connected to the heating block for adjusting its heating direction, and an open space formed between the stove assembly and the grill; and a drive assembly including a motor, gear means driven by the motor, and a shaft extended from the gear means through the grill into a center of the grill such that the grill is adapted to rotate in response to activating the motor. In one embodiment in response to adjusting the heating direction of the heating block to a downward direction, placing meat on the grill, and activating both the drive assembly and the heating block, an effective heat is transferred from the heating block to the meat.

### BACKGROUND OF THE INVENTION

1. Field of Invention

The present invention relates to cooking appliances and more particularly to a portable, multifunctional cooking apparatus.

2. Related Art

A conventional cooking apparatus such as gas stove or barbecue is intended for a single cooking purpose only. Moreover, for example, either stove or barbecue has its specific fuel such as gas bottle or charcoal. This also bothers users in preparing it before taking a picnic or the like. Thus, a need for improvement exists.

### SUMMARY OF THE INVENTION

It is therefore an object of the present invention to provide a multifunctional cooking apparatus comprising a grill assembly including a raised stand and a grill fitted on the stand; a stove assembly adapted to mount on the grill assembly and including a top opening, an internal heating block, a frame fitted on the opening, a pan fitted on the frame, a rotation adjustment knob on an outer surface of the stove assembly connected to the heating block for adjusting a heating direction of the heating block, and an open space formed between the stove assembly and the grill; and a drive assembly provided under the stand and including a motor, gear means driven by the motor, and a shaft extended from the gear means through the stand into a center of the grill such that the grill is adapted to rotate in response to activating the motor; wherein in response to adjusting the heating direction of the heating block to a downward direction, placing meat on the grill, and activating both the drive assembly and the heating block, an effective heat is transferred from the heating block to the meat.

In one aspect of the present invention, the pan is adapted to keep foodstuffs placed therein warm in the heat transfer.

In another aspect of the present invention, there is further provided a rack disposed on the frame, and wherein in response to adjusting the heating direction of the heating block to an upward direction, placing a pot filled with liquid on the rack, and activating both the drive assembly and the heating block, an effective heat is transferred from the heating block to the pot.

In yet another aspect of the present invention, the heating block is a stove powered by gas bottle.

In a further aspect of the present invention, the motor is a battery powered motor.

In yet further aspect of the present invention, the stove assembly is detached from the grill assembly and is placed upside down, both the frame and the pan are removed with the rack placed in the stove assembly, and the pot filled with liquid is placed on the rack such that adjusting the heating direction of the heating block toward the pot and activating both the heating block will transfer an effective heat from the heating block to the pot.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of multifunctional cooking apparatus according to the invention;

FIG. 2 is an exploded view of the cooking apparatus;

FIG. 3 is a sectional view of the cooking apparatus;

FIG. 4 is a top plan view of the cooking apparatus;

FIG. 5 is a side view of the cooking apparatus;

FIG. 6 is a view similar to FIG. 3 for illustrating the operation of drive assembly of the cooking apparatus;

FIG. 7 is a view similar to FIG. 5 for illustrating the operation of adjusting heating direction of heating block; and

FIG. 8 is a side view showing another configuration of the cooking apparatus.

### DETAILED DESCRIPTION OF THE INVENTION

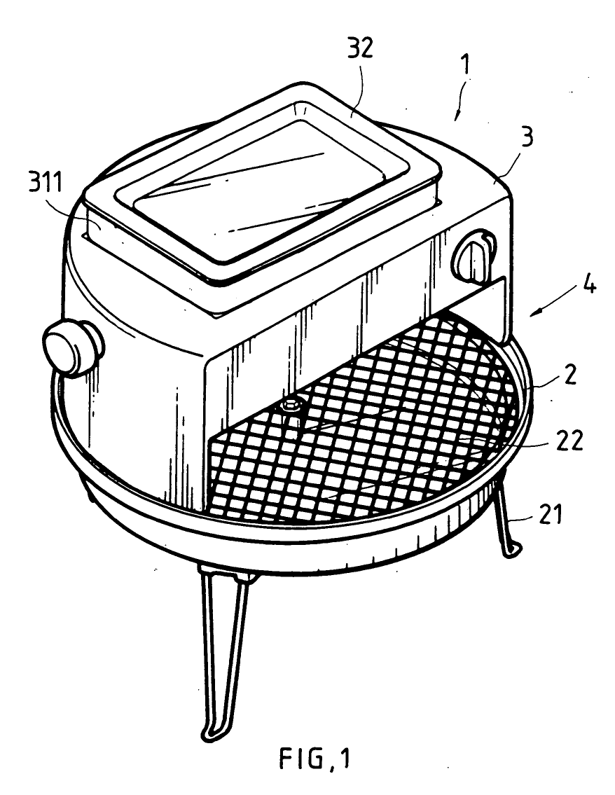

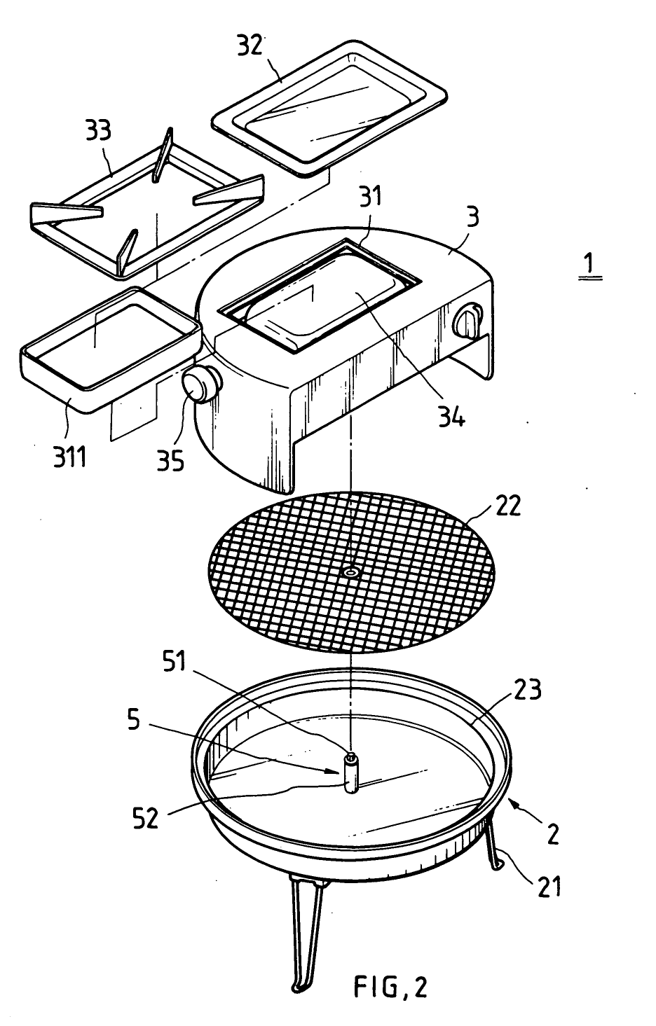

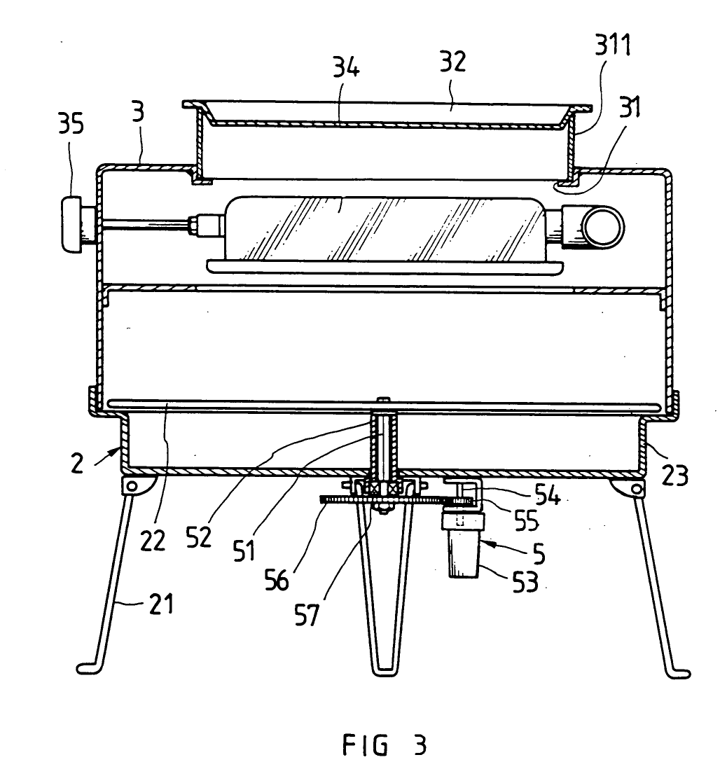

Referring to FIGS. 1 to 5, a multifunctional cooking apparatus 1 in accordance with a preferred embodiment of the invention comprises a grill assembly 2, a stove assembly 3, and a drive assembly 5. Each component is discussed in detailed below.

The grill assembly 2 comprises three equally spaced legs 21, a raised circular stand 23 formed on the legs 21, and a circular grill 22 fitted on the stand 23. The stove assembly 3 is adapted to mount on the grill assembly 2 in one configuration and comprises a rectangular top opening 31, a heating block (e.g., stove powered by gas bottle) 34 in the opening 31, a rotation adjustment knob 35 on an arcuate outer surface of the stove assembly 3 connected to the heating block 34 for adjusting its heating direction, a rectangular frame 311 fitted on the opening 31, and a pan 32 fitted on the frame 311. Alternatively, the pan 32 can be replaced by a rack 33 for other cooking purposes. An opening 4 is formed between the stove assembly 3 and the grill 22 such that a user may place meat on the grill 22 through the opening 4 for cooking or remove same through the opening 4 after cooking.

The drive assembly 5 is provided under the stand 23 and comprises a battery powered motor 53, a first shaft 54 rotatably extended from the motor 53, a pinion 55 fixedly put on the first shaft 54 and co-rotated therewith, a gear 56 in gear connection with the pinion 55, a second shaft 51 extended from a center of the gear 56 through a bottom of the stand 23 into a center of the grill 22, a sleeve 52 having its top in contact with the grill 22 and its lower portion formed with the bottom of the stand 23, and a bearing 57 formed on a bottom of the second shaft 51 under the gear 56.

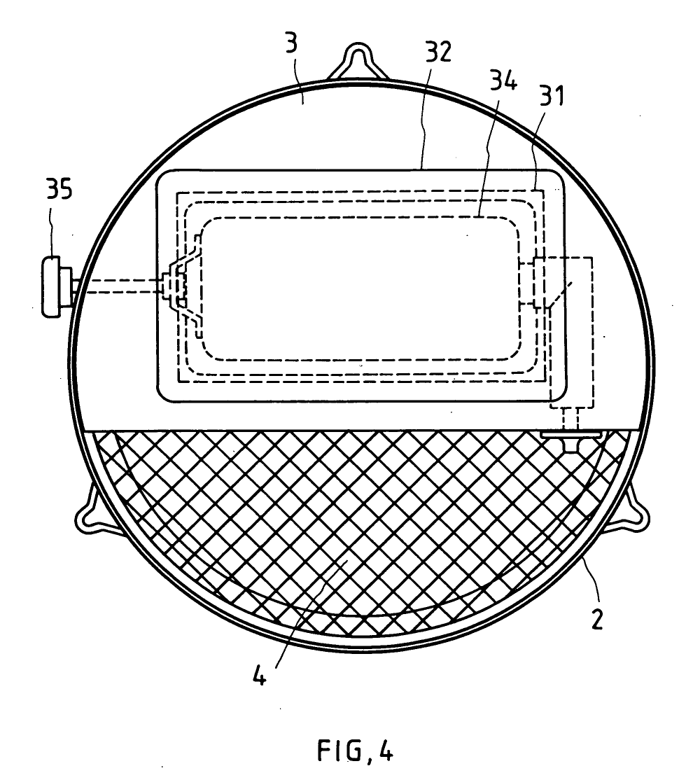

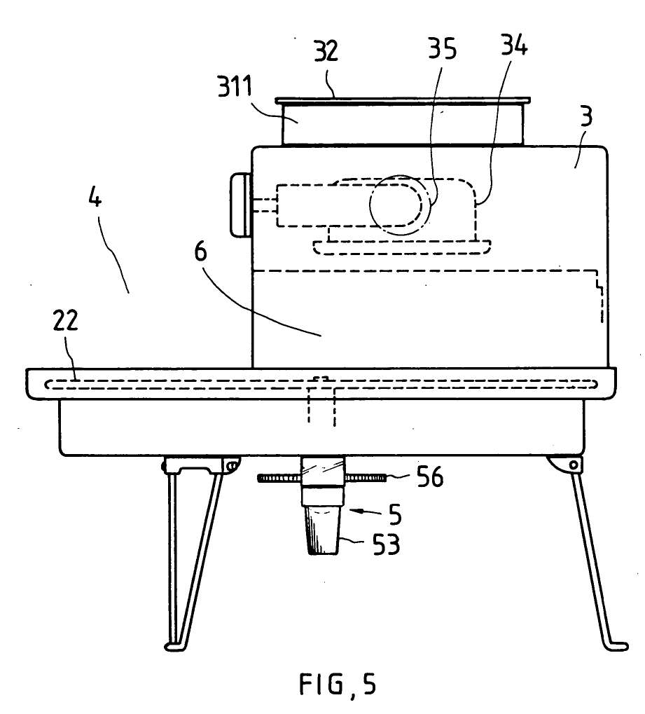

Referring to FIGS. 4 and 5 specifically, the heating block 34 has been adjusted to have its heating direction downward by operating the rotation adjustment knob 35. Thus, meat placed on the grill 22 can be well heated in a cooking zone 6 defined between the arcuate surface of the stove assembly 3 and the heating block 34 after activating the drive assembly 5. Moreover, foodstuffs placed in the pan 32 can be kept sufficiently warm by the heating block 34.

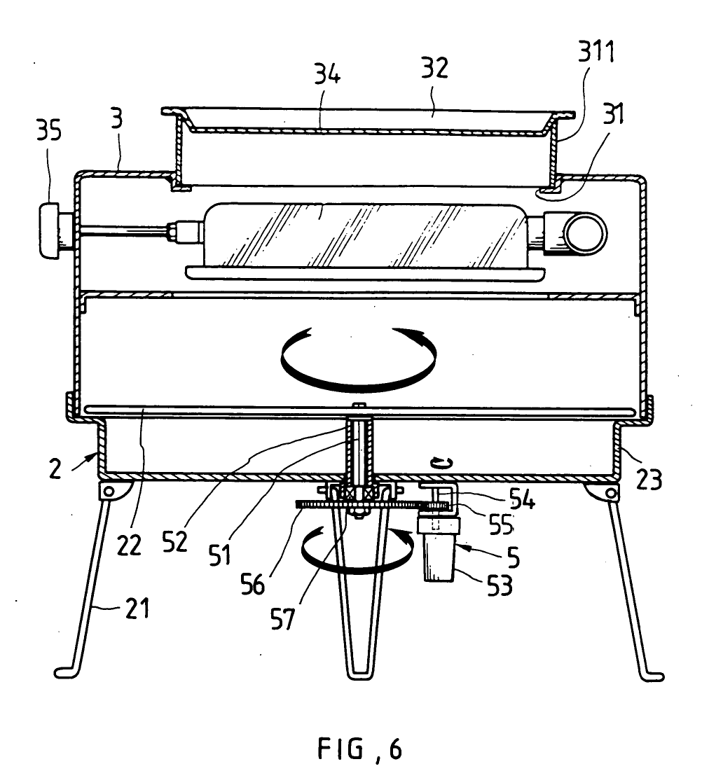

Referring to FIG. 6, an operation of the drive assembly 5 will be described in detailed below. In response to activating the drive assembly 5 the first shaft 54 rotates and the pinion 55 rotates same. Thus, the gear 56 rotates. And in turn, the second shaft 51 rotates to cause the grill 22 to rotate in a predetermined speed. As a result, meat on the rotating grill 22 can be well cooked by broiling.

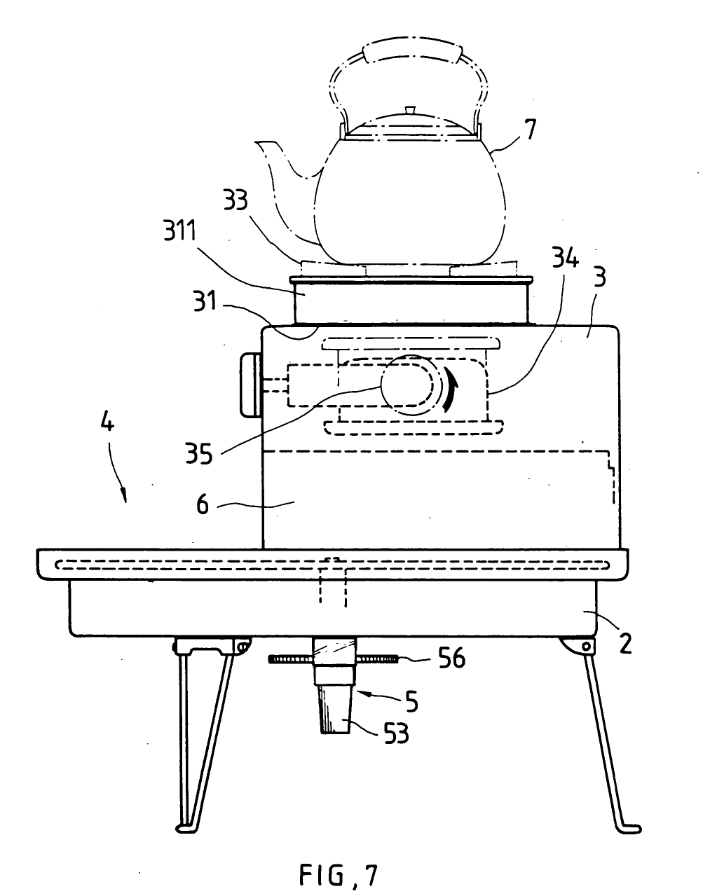

Referring to FIG. 7, an operation of adjusting the heating direction of the heating block 34 by operating the rotation adjustment knob 35 will be described in detailed below. In this configuration a pot 7 full of water is placed on the rack 33 which is supported by the frame 311 on the opening 31. Also, operating the rotation adjustment knob 35 to turn the heating block 34 to an upward heating direction for heating the pot 7.

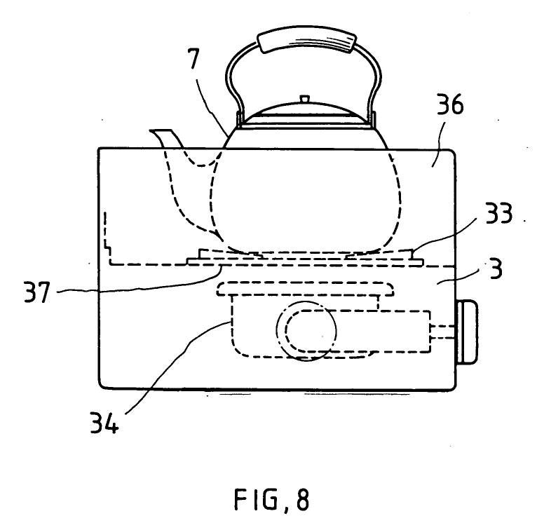

Referring to FIG. 8, the stove assembly 3 is detached from the grill assembly 2 and is used independently in a picnic or outdoor party. The stove assembly 3 is placed upside down. Also, both the frame 311 and the pan 32 are replaced by the rack 33 which is placed on another opening 37 of the stove assembly 3. Further, the pot 7 is placed on the rack 33. A portion of the arcuate surface of the stove assembly 3 is formed as a hood 36 for preventing strong wind from interfering with the heating of the pot 7.

While the invention herein disclosed has been described by means of specific embodiments, numerous modifications and variations could be made thereto by those skilled in the art without departing from the scope and spirit of the invention set forth in the claims.

What is claimed is:

1. A cooking apparatus comprising:
a grill assembly including a raised stand and a grill fitted on the stand;
a stove assembly adapted to mount on the grill assembly and including a top opening, an internal heating block, a frame fitted on the opening, a pan fitted on the frame, a rotation adjustment knob on an outer surface of the stove assembly connected to the heating block for adjusting a heating direction of the heating block, and an open space formed between the stove assembly and the grill; and
a drive assembly provided under the stand and including a motor, gear means driven by the motor, and a shaft extended from the gear means through the stand into a center of the grill such that the grill is adapted to rotate in response to activating the motor;
wherein in response to adjusting the heating direction of the heating block to a downward direction, placing meat on the grill, and activating both the drive assembly and the heating block, an effective heat is transferred from the heating block to the meat.

2. The cooking apparatus of claim 1, wherein the pan is adapted to keep foodstuffs placed therein warm in the heat transfer.

3. The cooking apparatus of claim 1, further comprising a rack disposed on the frame, and wherein in response to adjusting the heating direction of the heating block to an upward direction, placing a pot filled with liquid on the rack, and activating both the drive assembly and the heating block, an effective heat is transferred from the heating block to the pot.

4. The cooking apparatus of claim 1, wherein the heating block is a stove powered by gas bottle.

5. The cooking apparatus of claim 1, wherein the motor is a battery powered motor.

6. The cooking apparatus of claim 3, wherein the stove assembly is detached from the grill assembly and is placed upside down, both the frame and the pan are removed with the rack placed in the stove assembly, and the pot filled with liquid is placed on the rack such that adjusting the heating direction of the heating block toward the pot and activating both the heating block will transfer an effective heat from the heating block to the pot.
